(19) United States
(12) Patent Application Publication
(10) Pub. No.: US 2013/0341120 A1
(43) Pub. Date: Dec. 26, 2013

(54) SOUNDPROOF MATERIAL USING POLYURETHANE FOAM FROM CAR SEAT AND FABRICATION PROCESS THEREOF

(71) Applicants: HYUNDAI MOTOR COMPANY, Seoul (KR); KIA MOTORS CORPORATION, Seoul (KR)

(72) Inventors: Hong Mo Koo, Hwaseong (KR); Jae Eun Chang, Hwaseong (KR); June Ho Yang, Seoul (KR); Dong Jun Lee, Seoul (KR)

(73) Assignees: KIA MOTORS CORPORATION, Seoul (KR); HYUNDAI MOTOR COMPANY, Seoul (KR)

(21) Appl. No.: 13/625,062

(22) Filed: Sep. 24, 2012

(30) Foreign Application Priority Data
Jun. 25, 2012 (KR) 10-2012-0068246

(51) Int. Cl. E04B 1/84; B32B 43/00

(52) U.S. Cl. 181/290; 156/94

(57) ABSTRACT

Disclosed is a soundproof material fabricated using recycled polyurethane foam from waste seats and a process of fabricating the same, and more particularly, a soundproof material fabricated by stacking a thermoplastic polymer on a sound absorbing material including recycled polyurethane foam from seats from end-of-life vehicles and a process of fabricating the same. Use of recycled resources provides an eco-friendly impact, reduces manufacturing costs for parts, and allows for improved mechanical rigidity and sound insulating properties. The soundproof material may be applied to various automobile parts such as package trays, luggage coverings, covering shelves, and isolation pads.

### CROSS-REFERENCE TO RELATED APPLICATION

This application claims under 35 U.S.C. §119(a) the benefit of Korean Patent Application No. 10-2012-0068246 filed Jun. 25, 2012, the entire contents of which are incorporated herein by reference.

### BACKGROUND

(a) Technical Field

The present disclosure relates to a soundproof material fabricated using recycled polyurethane foam, particularly polyurethane foam recycled from seats of vehicles and a process of fabricating the same.

(b) Background Art

In general, car seats are made of polyurethane foam, with the weight of polyurethane foam per vehicle totaling about 10 kg. Currently, car seats are scrapped along with other parts of end-of-life vehicles. While research into techniques of recycling auto parts made from thermoplastic materials has been vigorously conducted, most of the seat foam a thermoset material which difficult to recycle and, thus, is sent to landfills or treated by combustion. This results in soil contamination and environmental pollution. Furthermore, according to The Directive 2000/53/EC of the European Parliament and of the Council on end-of-life vehicles, the re-use and recycling for all end-of-life vehicles shall be increased to a minimum of 85% and the thermal recovery shall be increased to a minimum of 95% until 2015. Sales of vehicles which do not meet these requirements will be restricted in the European Union, and, thus, much attention has been paid to the re-use and recycling of end-of-life vehicles.

Methods of treating seat foam (thermosetting polyurethane foam) may be generally classified into physical recycling methods including washing, scrapping, and re-processing, and chemical recycling methods including chemical reactions such as depolymerization. For example, chemical recycling of polyurethane can be carried out by depolymerization using various solvents and which includes hydrolysis, depolymerization by using various glycols, and depolymerization by using amines. However, chemical recycling is not economical and has not been commercialized due to the low conversion rate and low yield. The use of conventional physical recycling methods, such as crushing and using polyurethane foam as a filler of injection-molded or extrusion-molded products or as thickener of polyurethane-based adhesives, or by crushing and pressing polyurethane form to form a rebonded foam, is limited. As such, conventional methods for recycling thermosetting polyurethane foam have not been commercialized due to low economical efficiency, low performance of products, and absence of the use thereof.

As a soundproof material manufactured from waste seat foam, Korean Patent Application Publication No. 2011-0089468 describes a noise absorption material for vehicles manufactured by adhering olefin-based powder or ethylene vinyl acetate (EVA) to the surface of scraps of waste polyurethane foam, disposing them between polyethylene terephthalate (PET) fibers to form a stack, heating and cooling the stack to prepare a fiber board, and pressing the fiber board using a mold via pre-heating. However, due to power type binders used to form the structure of noise absorption materials, a process of preparing the noise absorption material is further required and, thus, manufacturing costs therefor increase. In addition, polyurethane foams typically have excellent sound absorbing property due to their porous structure. However, with the described materials, the pores of the surface of the polyurethane foam are coated with olefin-based powder or aqueous EVA, which may deteriorate thir sound absorbing properties.

Korean Patent Application Publication No. 2003-0000746 also describes a sound absorbing and insulating material for automobiles including polyurethane-based films interposed between layers of a multi-layered structure. In particular, the multi-layered structure includes (a) a low-density soft upper layer including PET, a low melting point binder fiber, and PET/PP, (b) a high-density soft intermediate layer including a PET fiber, a low melting point binder fiber, and PET/PP, and (c) a high-density soft bottom layer including a PET fiber, a low melting point binder fiber, and PET/PP. However, the weight of the material considerably increases while forming the multi-layered structure, and thus the material cannot be applied to lightweight parts. Further, a large amount of fiber dust is generated during production.

As described above, urethane foam, recycling fabric felt, glass fiber, general PET fiber, and the like are used as materials for soundproofing auto parts. However, glass fibers and recycling fabric felt, and additives used in the preparation thereof, are not eco-friendly, thus decreasing their use. Polyurethane foam is light and has excellent sound absorbing properties, but has low mechanical strength and poor heat resistance. Polypropylene (PP)-fiber board and polyethylene terephthalate (PET) felt are generally used in consideration of their costs and functions. However, although the PP-fiber board is inexpensive, it has poor sound absorbing property. Further, PET felt is heavy, generates fiber dust, and has poor sound insulating properties. Thus, there is a need to develop a light soundproof material with excellent sound absorbing and insulating properties.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention has been made in an effort to solve the above-described problems associated with prior art. In order to recycle seats of end-of-life vehicles that are typically sent to landfills or treated by combustion, and to provide the thermosetting material with improved mechanical rigidity and sound insulating properties suitable for automobiles, the seats undergo a series of processes. In particular, the seats are collected/pre-treated and crushed, the crushed seats are mixed with a thermoplastic fiber, and the mixture is processed by carding, stacking, needle-punching, and heat-rolling to prepare a sound absorbing material, and a thermoplastic polymer is stacked on the surface of the sound absorbing material to prepare a soundproof material. Accordingly, eco-friendly property may be improved by using recycled resources, manufacturing costs for parts may be reduced, mechanical rigidity may be improved, and sound insulating properties may be improved.

Thus, an object of the present invention is to provide a soundproof material fabricated by using recycled polyurethane foam from vehicle seats, such as seats from end-of-life vehicles.

A further object of the present invention is to provide a soundproof material having excellent mechanical rigidity and excellent sound insulating properties.

In one aspect, the present invention provides a soundproof material comprising: a sound absorbing material comprising crushed polyurethane (PU) foam, a polyester-based fiber, and a low melting point polyester-based fiber; and a thermoplastic polymer.

In another aspect, the present invention provides a process of fabricating a soundproof material, the process comprising the steps of:

(a) crushing polyurethane (PU) foam, particularly polyurethane foam from waste vehicle seats, into fine particles;

(b) preparing a sound absorbing material by mixing the crushed polyurethane foam obtained in step (a) with a polyester-based fiber and a low melting point polyester-based fiber;

(c) carding the sound absorbing material;

(d) needle-punching the sound absorbing material;

(e) thermal-molding and cooling the sound absorbing material, particularly so as to provide a felt shape; and

(f) impregnating the sound absorbing material prepared in step (e) with a thermoplastic polymer resin or laminating a thermoplastic polymer film on the sound absorbing material, and heat-rolling and cutting the resultant material.

In still another aspect, the present invention provides a soundproof material having a stack structure that comprises: a sound absorbing layer that is a foam fiber, preferably in the form of a felt, comprising a crushed polyurethane foam, a polyester-based fiber, and a low melting point polyester-based fiber; and a sound insulating layer that comprises a fiber board formed of a polyester-based fiber, a low melting point polyester-based fiber, and a polypropylene fiber, and a thermoplastic polymer.

In a further aspect, the present invention provides a process of fabricating a soundproof material, the process comprising the steps of:

(a) crushing polyurethane (PU) foam, particularly polyurethane foam from waste vehicle seats, into fine particles;

(b) preparing a sound absorbing material by mixing the crushed polyurethane foam obtained in step (a) with a polyester-based fiber and a low melting point polyester-based fiber;

(c) carding the sound absorbing material;

(d) needle-punching the sound absorbing material;

(e) thermal-molding and cooling the sound absorbing material;

(f) preparing a sound insulating material by mixing a polyester-based fiber, a low melting point polyester-based fiber, and a polypropylene fiber;

(g) carding the sound insulating material;

(h) needle-punching the sound insulating material;

(i) thermal-molding and cooling the sound insulating material, particularly so as to provide a felt shape;

(j) impregnating the sound insulating material prepared in step (i) with a thermoplastic polymer resin or laminating a thermoplastic polymer film on the sound insulating material, and heat-rolling and cutting the resultant material; and

(k) stacking the sound absorbing layer and the sound insulating layer, which may respectively be formed in felt shapes in steps (e) and (j), and heat-rolling and cutting the stack.

Other aspects and preferred embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The above and other features of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 shows a cross-sectional view of a sound absorbing material prepared by recycling polyurethane foam of waste seats according to an embodiment of the present invention;

FIG. 2 schematically shows a process of fabricating a soundproof material according to an embodiment of the present invention;

FIG. 3 shows a cross-sectional view of a soundproof material prepared in Example 1 or 2 according to the present invention;

FIG. 4 shows a cross-sectional view of a soundproof material prepared in Example 3 according to the present invention;

FIG. 5 is a cross-sectional view of a soundproof material having a sound absorbing layer/sound insulating layer/sound absorbing layer structure prepared in Example 4 or 5 according to the present invention;

FIG. 6 is a cross-sectional view of a soundproof material having a sound insulating layer/sound absorbing layer/sound insulating layer structure prepared in Example 4 or 5 according to the present invention;

FIG. 7 is a flow chart schematically describing a process of fabricating a soundproof material according to an embodiment of the present invention;

FIG. 8 schematically shows a process of preparing a package tray for auto parts using soundproof materials prepared in Examples 1, 2, 3, 4, and 5 according to the present invention;

FIG. 9 schematically shows an impregnation process of Example 1 according to the present invention;

FIG. 10 schematically shows a process of preparing a pasteboard of Example 2 according to the present invention;

FIG. 11 schematically shows a process of preparing a two-sided pasteboard of Examples 3, 4, and 5 according to the present invention;

FIG. 12 is a graph illustrating sound absorption efficiency according to Examples 3 and 4 according to the present invention and Comparative Example 2 measured in a reverberation room; and

FIG. 13 is a graph illustrating sound insulation efficiency according to Examples 3 and 4 according to the present invention and Comparative Example 2 measured in a reverberation room.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Ranges provided herein are understood to be shorthand for all of the values within the range. For example, a range of 1 to 50 is understood to include any number, combination of numbers, or sub-range from the group consisting of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

According to an embodiment of the present invention, there is provided a soundproof material including a sound absorbing material that is formed of crushed polyurethane (PU) foam, a polyester-based fiber, and a low melting point polyester-based fiber, and a thermoplastic polymer.

The polyurethane foam can come from a variety of sources, and according to preferred embodiments, the polyurethane foam is waste polyurethane foam from the seats of end-of-life vehicles. For example, seat foam from end-of-life vehicles may be crushed, or thermosetting polyurethane foam may be formed into fine particles using a cylindrical crusher. According to embodiments of the present invention, the thus provided polyurethane foam is used as a main component of a sound absorbing material. According to various embodiments, other fibers may be added to the polyurethane foam in order to adjust the costs of materials and to provide a desired balance of properties.

The polyester-based fiber can be selected from any known polyester-based fibers, including but not limited to polyglycolic acid (PGA), poly lactic acid (PLA), polyethylene polyethylene adipate (PEA), polyhydroxy alkanoate (PHA), polyethylene terephthalate (PET), polybutylene terephthalate (PBT), polytrimethylene terephthalate (PTT), polyethylene naphthalate (PEN), and combinations thereof. The low melting point polyester-based fiber can also be selected from any known low melting point polyester-based fibers, and are generally those which have a relatively lower melting point than the previously mentioned polyester-based fibers. Some examples of suitable low melting point polyester-based fibers include, but are not limited to, those having a melting point of up to about 190° C., for example, about 110-180° C.

The thermoplastic polymer may include acrylonitrile-butadiene-styrene (ABS), celluloid, cellulose acetate, ethylene-vinyl acetate, ethylene vinyl alcohol, polyoxy methylene, polyacrylate, polyamide, polyamide imide, polyaryl etherketon, polybutadiene, polybutylene, polybutylene terephthalate, polycaprolactone, polyethylene terephthalate, polycyclohexylene dimethylene terephthalate, polycarbonate, polyethylene, polyether imide, polyimide, polylactic acid, polymehtyl pentene, polyphenylene oxide, polyphenylene sulfide, polyphtalamide, polypropylene, polystyrene, polysulfone, polyurethane, polyvinyl acetate, polyvinyl chloride, styrene-acrylonitrile, and combinations thereof.

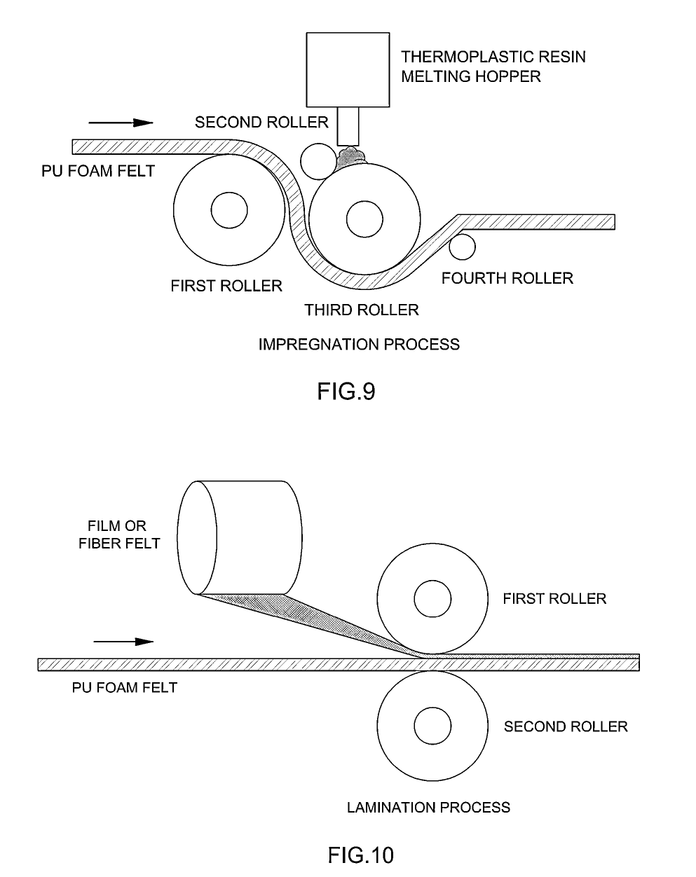

According to various embodiments, the thermoplastic polymer is in the form of a thermoplastic resin or thermoplastic film. In this regard, the thermoplastic resin can be melted at a temperature ranging from about 150 to 260° C. depending upon the type of the resin, and impregnated on the surface of the sound absorbing material using any conventional means such as a roller or a melting furnace, and the thermoplastic film may be laminated on the surface of the sound absorbing material by using a heat roller having a surface temperature ranging from about 80 to 260° C. (Refer to FIGS. 9 and 10).

According to various embodiments, the sound absorbing material includes about 10 to 80 wt % of the crushed PU foam, about 10 to 60 wt % of the polyester-based fiber, and about 10 to 60 wt % of the low melting point polyester-based fiber based on the total weight of the sound absorbing material. According to various embodiments, the thermoplastic polymer includes about 1 to 50 wt % of the thermoplastic resin or about 1 to 500 g/m² of the thermoplastic film based on the weight of the sound absorbing material.

According to various embodiments, the sound absorbing material further includes about 1 to 50 wt % of a polypropylene (PP) fiber, about 1 to 30 wt % of a glass fiber, and about 1 to 30 wt % of yarn or 1 to 30 wt % of any mixture thereof. In this regard, the yarn may be any conventional yarn, including but not limited to jute, flax, linen, hemp, ramie, and mixtures thereof.

According to various embodiments, the soundproof material includes about 100 to 3000 g/m² of the sound absorbing material, and the thermoplastic polymer includes about 1 to 50 wt % of the thermoplastic resin or about 1 to 500 g/m² of the thermoplastic film based on the weight of the sound absorbing material.

Meanwhile, according to another embodiment of the present invention, there is provided a process of fabricating a soundproof material, the process including: the steps of:

(a) crushing PU foam, such as PU foam from vehicle waste seats, into fine particles;

(b) preparing a sound absorbing material by mixing crushed PU foam obtained in step (a) with a polyester-based fiber and a low melting point polyester-based fiber;

(c) carding the sound absorbing material;

(d) needle-punching the sound absorbing material;

(e) thermal-molding and cooling the sound absorbing material, particularly so as to provide a felt shape; and

(f) impregnating the sound absorbing material prepared in step (e) with a thermoplastic polymer resin or laminating a thermoplastic polymer film on the sound absorbing material, and heat-rolling and cutting the resultant material.

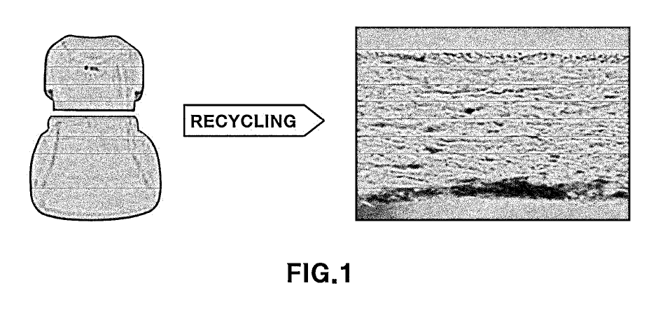

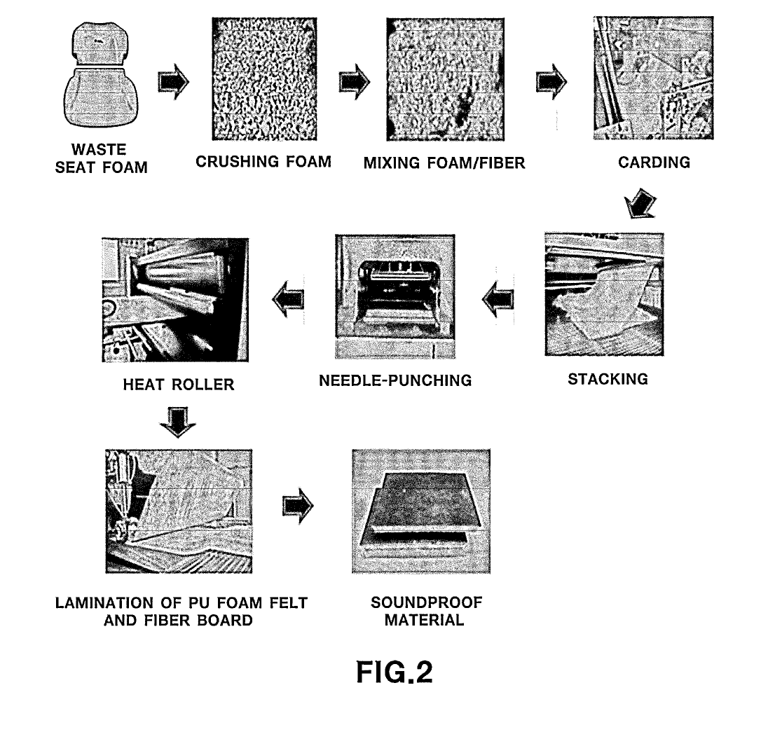

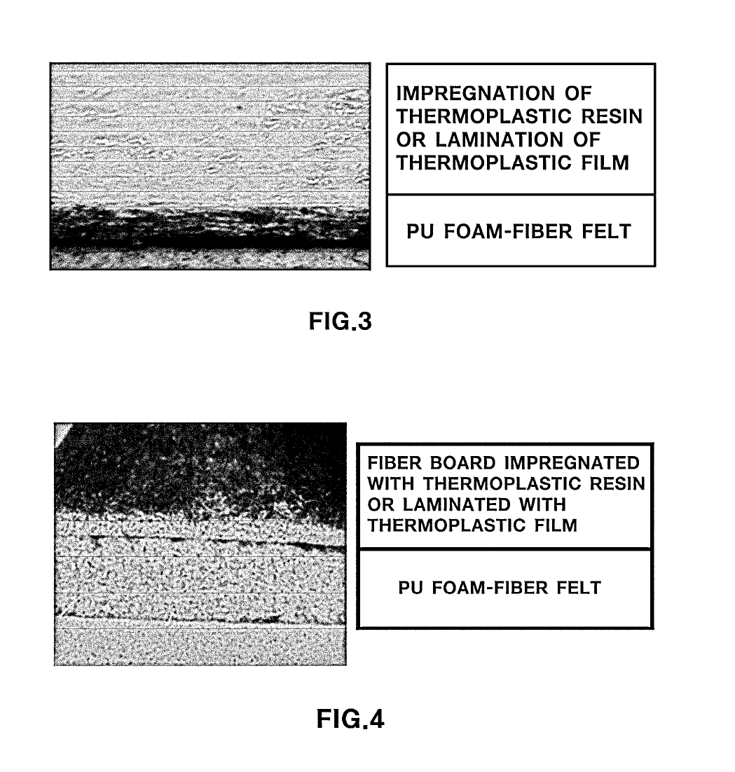

In step (b), since the crushed PU foam cannot be re-processed by heat (unlike the thermoplastic polymer), the PU form may be crushed into fine particles. In particular, according to various embodiments, the PU foam is crushed into fine particles having a particle size ranging from about 1 to 15 mm as shown in FIG. 1. Preferably, the particle size of the crushed foam is in the range of about 2 to 5 mm. If the particle size of the crushed foam is greater than about 15 mm, a product formed therefrom may not have a uniform surface. On the other hand, if the particle size of the crushed foam is less than about 1 mm, the potential for loss of the particles during the mixing with fibers increases, and the particles may not be uniformly distributed in the fiber.

According to various embodiments, the sound absorbing material includes about 10 to 80 wt % of the crushed PU foam, about 10 to 60 wt % of the polyester-based fiber, and about 10 to 60 wt % of the low melting point polyester-based fiber based on the total weight of the sound absorbing material. According to various embodiments, the thermoplastic polymer includes about 1 to 50 wt % of the thermoplastic resin or about 1 to 500 g/m² of the thermoplastic film based on the weight of the sound absorbing material. The sound absorbing material may further include about 1 to 50 wt % of a polypropylene (PP) fiber, about 1 to 30 wt % of a glass fiber, and about 1 to 30 wt % of yarn or about 1 to 30 wt % of any mixture thereof (i.e., about 1 to 30 wt % of a mixture of PP fiber, glass fiber and/or yarn).

The soundproof material may include about 100 to 3000 g/m² of the sound absorbing material, and the thermoplastic polymer may include about 1 to 50 wt % of the thermoplastic resin or about 1 to 500 g/m² of the thermoplastic film based on the weight of the sound absorbing material.

According to another embodiment the present invention, there is provided a soundproof material that has a stack structure including: a sound absorbing layer that is formed of a foam fiber felt including crushed PU foam, a polyester-based fiber, and a low melting point polyester-based fiber; and a sound insulating layer that is formed of a fiber board including a polyester-based fiber, a low melting point polyester-based fiber, and a PP fiber and a thermoplastic polymer (Refer to FIG. 4).

The thermoplastic polymer may be in the form of a thermoplastic resin or thermoplastic film. In this regard, the thermoplastic resin can be melted at a temperature ranging from about 150 to 260° C., depending on the type of the resin, and impregnated on the surface of the sound absorbing material (e.g. by using a roller or a melting furnace). The thermoplastic film may be laminated on the surface of the sound absorbing material by using a heated roller having a suitable surface temperature, such as a temperature ranging from about 80 to 260° C. (Refer to FIGS. 9 and 10).

According to various embodiments, the sound absorbing layer includes about 10 to 80 wt % of the crushed PU foam, about 10 to 60 wt % of the polyester-based fiber, and about 10 to 60 wt % of the low melting point polyester-based fiber based on the total weight of the sound absorbing layer. The sound insulating layer may include about 10 to 60 wt % of the polyester-based fiber, about 10 to 60 wt % of the low melting point polyester-based fiber, about 10 to 50 wt % of the PP fiber, and about 1 to 50 wt % of the thermoplastic resin or about 1 to 500 g/m² of the thermoplastic film as the thermoplastic polymer based on the weight of the sound insulating layer. According to various embodiments, the sound absorbing layer and/or the sound insulating layer may further include about 1 to 50 wt % of a PP fiber, about 1 to 30 wt % of a glass fiber, about 1 to 30 wt % or yarn, or about 1 to 30 wt % of any mixture thereof (i.e. a mixture of one or more of PP fiber, glass fiber and yarn).

According to various embodiments, the soundproof material includes about 100 to 3000 g/m² of the sound absorbing layer and about 50 to 1000 g/m² of the sound insulating layer.

According to another embodiment of the present invention, there is provided a process of fabricating a soundproof material, the process including the steps of:

(a) crushing PU foam, preferably polyurethane foam from vehicle waste seats, into fine particles;

(b) preparing a sound absorbing material by mixing the crushed PU foam obtained in step (a) with a polyester-based fiber and a low melting point polyester-based fiber;

(c) carding the sound absorbing material;

(d) needle-punching the sound absorbing material;

(e) thermal-molding and cooling the sound absorbing material, particularly so as to provide a felt shape;

(f) preparing a sound insulating material by mixing a polyester-based fiber, a low melting point polyester-based fiber, and a PP fiber;

(g) carding the sound insulating material;

(h) needle-punching the sound insulating material;

(i) thermal-molding and cooling the sound insulating material, particularly so as to provide a felt shape;

(j) impregnating the sound insulating material prepared in step (i) with a thermoplastic polymer resin or laminating a thermoplastic polymer film on the sound insulating material, and heat-rolling and cutting the resultant material; and

(k) stacking the sound absorbing layer and the sound insulating layer, which are respectively formed in steps (e) and (j), and heat-rolling and cutting the stack.

The sound absorbing layer may include about 10 to 80 wt % of the crushed PU foam, about 10 to 60 wt % of the polyester-based fiber, and about 10 to 60 wt % of the low melting point polyester-based fiber based on the total weight of the sound absorbing layer. The sound insulating layer may include about 10 to 60 wt % of the polyester-based fiber, about 10 to 60 wt % of the low melting point polyester-based fiber, about 10 to 50 wt % of the PP fiber, and about 1 to 50 wt % of the thermoplastic resin or about 1 to 500 g/m² of the thermoplastic film as the thermoplastic polymer based on the weight of the sound insulating layer. According to various embodiments, the sound absorbing layer and/or the sound insulating layer may further include one or more of a PP fiber, a glass fiber, and/or a yarn. For example, the sound absorbing layer and/or the sound insulating layer may further include about 1 to 50 wt % of a PP fiber, about 1 to 30 wt % of a glass fiber, about 1 to 30 wt % or yarn, or about 1 to 30 wt % of any mixture (PP fiber, glass fiber, and/or yarn) thereof.

According to various embodiments, the soundproof material may include about 100 to 3000 g/m² of the sound absorbing layer and about 50 to 1000 g/m² of the sound insulating layer.

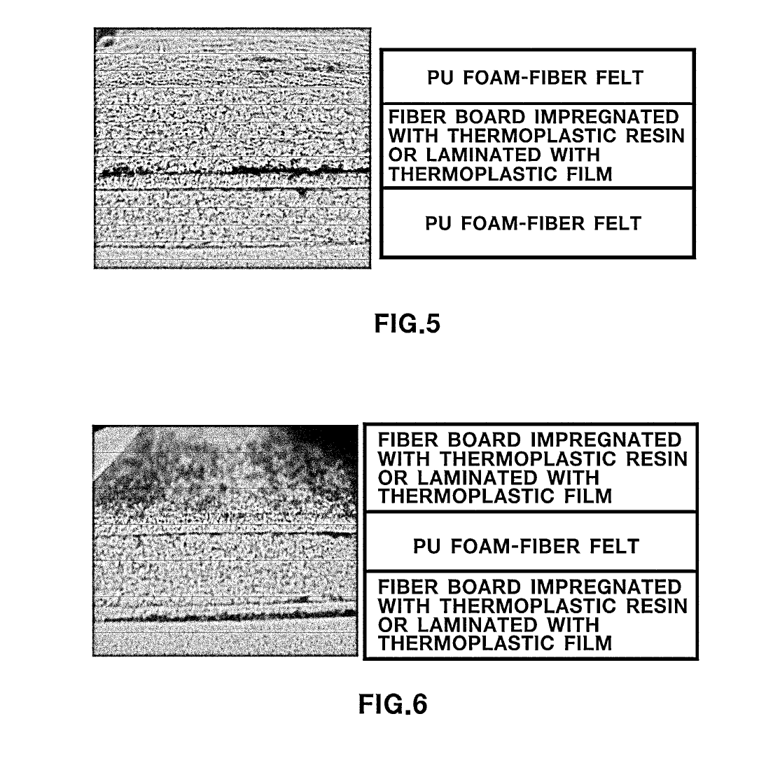

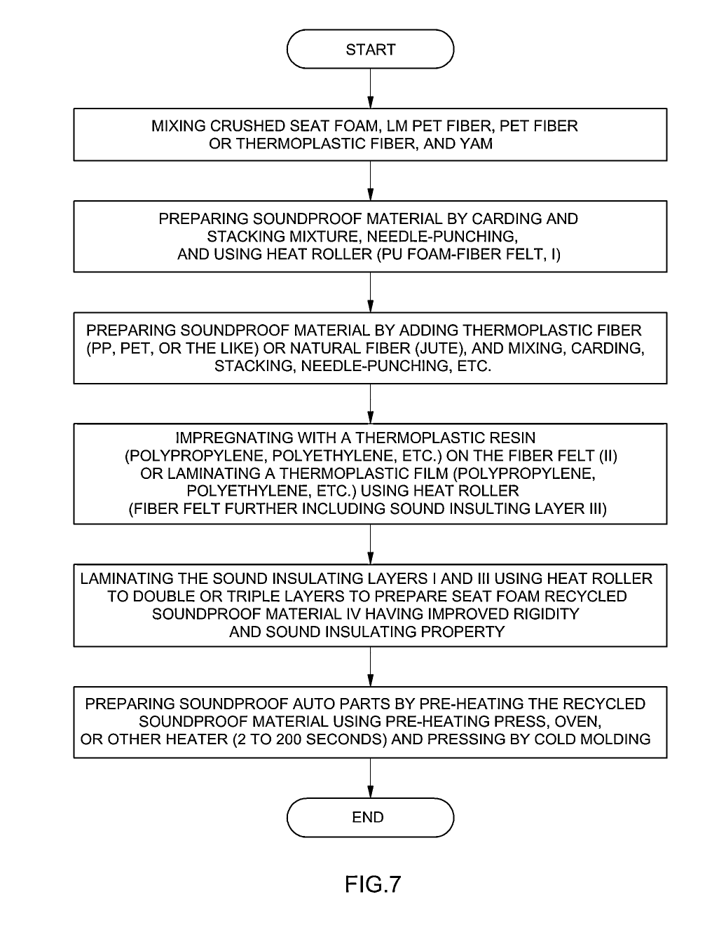

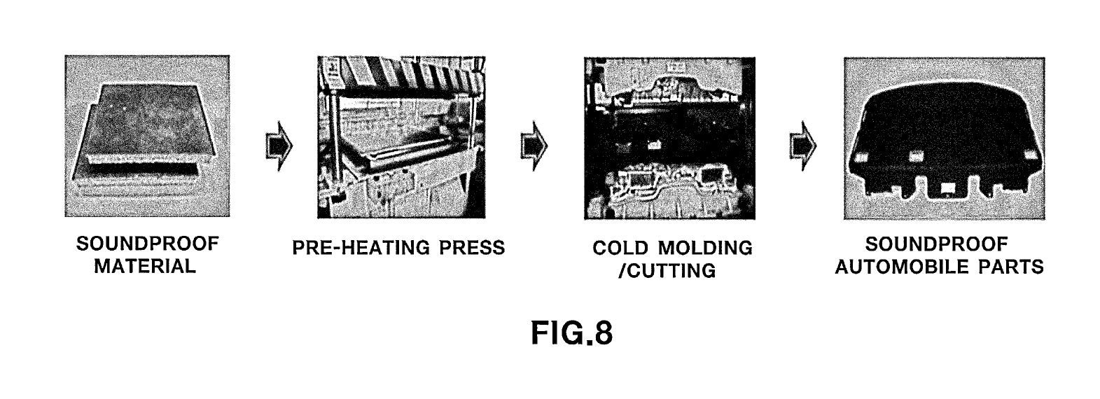

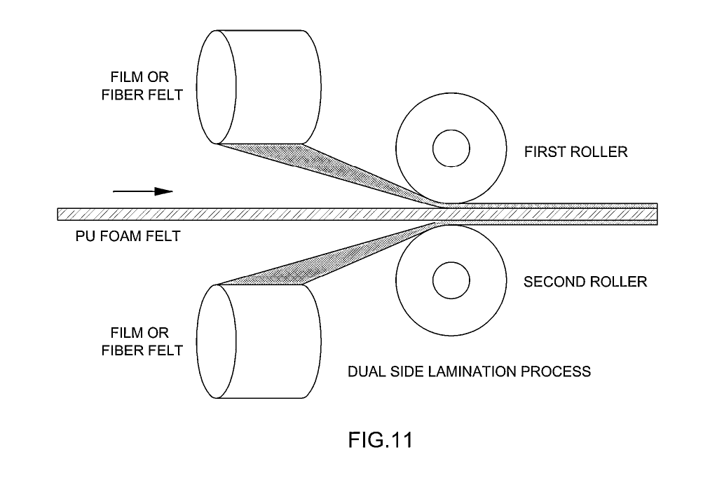

According to various embodiments of the present invention, the soundproof material may have various multi-layered structures. For example, according to an exemplary embodiment, the soundproof material has a layered structure of: a sound absorbing layer/sound insulating layer/sound absorbing layer by stacking a further sound absorbing layer on the sound insulating layer (FIG. 5). According to another exemplary embodiment, the soundproof material has a layered structure of: a sound insulating layer/sound absorbing layer/sound insulating layer structure by stacking the sound insulating layer on the sound absorbing layer (FIG. 6). In this regard, if the soundproof materials are stacked to form a multi-layered structure, the materials (e.g., felts) may be stacked in upper, middle, and lower layers according to the stack structure as shown in FIG. 11, pre-heated to a suitable temperature (e.g., by passing through a heated oven or a ceramic heater at about 120 to 260° C.) such that the surface temperatures of the materials (felts) are in the desired range (e.g., a temperature of about 120 to 250° C.), and processed by using a heat-roller or the like to form a multi-layered structure (FIGS. 10 and 11).

The soundproof material fabricated by using the method as described above may be provided with improved physical properties such as improved absorption coefficient and sound transmission loss. For example, an absorption coefficient of 0.50 to 0.57 at 1.0 Khz, an absorption coefficient of 0.66 to 0.69 at 2.0 khz, and an absorption coefficient of 0.79 to 0.83 at 3.15 khz may be obtained, and a sound transmission loss of 12.9 to 18.6 dB at 1.0 Khz, a sound transmission loss of 16.9 to 19.9 dB at 2.0 khz, and a sound transmission loss of 16.5 to 28.2 dB at 3.15 khz may be obtained. In addition, a soundproof board can be prepared, which is prepared by disposing the prepared soundproof material in a heated press at a heightened temperature (e.g., a temperature ranging from about 190 to 230° C.), pre-heating the soundproof material in the heated press for a suitable period of time to heighten the temperature of the soundproof material (e.g., preheating for about 20 to 200 seconds), and cold molding the soundproof material. A soundproof board thus prepared can be provided with a bursting strength of about 25 to 50 kgf/cm².

As described above, the soundproof material prepared by using PU foam, such as PU foam from recycled seats of end-of-life vehicles, may have equal or better performance than PET felts or natural fiber reinforced boards which are commonly used in the art for the soundproof material. In addition, if the recycled soundproof materials of the invention are utilized for more than 50% of the soundproof parts of vehicles as compared with the conventional soundproof material, manufacturing costs may be reduced by about 10 to 15%, the recycling rate of end-of-life vehicles may be increased by 0.7%, and an eco-friendly effect may be obtained by recycling waste.

In addition, the soundproof material of the present invention is provided with excellent sound absorbing property, excellent sound insulating property, and high mechanical strength, and may be applied to soundproof parts of vehicles so as to efficiently cope with domestic and overseas end-of-life vehicles directives. The soundproof material may be applied to any variety of automobile parts including those that require rigidity such as package trays, luggage coverings, covering shelves, and isolation pads.

The present invention, thus, provides a technique for recycling thermosetting foams, such as thermosetting vehicle seat foam of end-of-life cars. In particular, the thermosetting seat foam is recycled for use in forming soundproof materials for various vehicle parts, thereby addressing environmental concerns and reducing manufacturing costs for automobile parts.

Hereinafter, an example of the present invention will be described in detail, but the present invention is not limited to this example.

### EXAMPLES

The following examples illustrate the invention and are not intended to limit the same.

### Example 1

10 wt % of a PET fiber, 10 wt % of a LM PET fiber, 10 wt % of a PP fiber, and 20 wt % of a thermoplastic resin were introduced into 50 wt % of thermosetting polyurethane foam obtained by crushing PU foam from seats of end-of-life vehicles into fine particles. This process resulted in at least some impregnation of the thermoplastic resin instead of the fibers, which increased mechanical strength of a product, but resulted in partial coating of the mixture with the melted thermoplastic resin which decreased the sound absorbing property and dimensional stability of the product.

### Example 2

10 wt % of a PET fiber, 10 wt % of a LM PET fiber, 20 wt % of a PP fiber, and 50 g/m² of a thermoplastic film were introduced into 50 wt % of thermosetting polyurethane foam obtained by crushing PU foam from seats of end-of-life vehicles into fine particles. A product prepared by laminating the thermoplastic film thereon had better sound insulating property and higher mechanical strength than those prepared according to Comparative Examples 1 and 2.

### Example 3

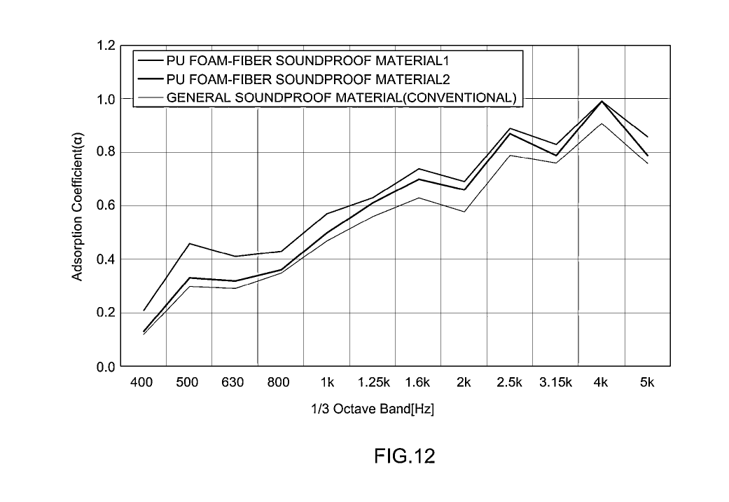

A sound absorbing layer including 50 wt % of thermosetting polyurethane foam obtained by crushing PU foam from waste seats from end-of-life vehicles into fine particles, 10 wt % of a PET fiber, 20 wt % of a LM PET fiber, and 20 wt % of a PP fiber and a sound insulating layer including 20 wt % of a PET fiber, 40 wt % of a LM PET fiber, 20 wt % of a PP fiber, and 20 wt % of a thermoplastic resin were laminated together. Since the sound insulating layer impregnated with the thermoplastic resin was laminated, the soundproof material demonstrated better sound insulating property than those of Comparative Examples 1 and 2 and better mechanical strength than that of Comparative Example 3 (FIGS. 11 and 12).

### Example 4

A sound insulating layer including 30 wt % of a PET fiber, 40 wt % of a LM PET fiber, 30 wt % of a PP fiber, and 50 g/m² of a thermoplastic resin was laminated on one surface of a sound absorbing layer including 50 wt % of thermosetting polyurethane foam obtained by crushing PU foam from seats of end-of-life vehicles into fine particles, 10 wt % of a PET fiber, 20 wt % of a LM PET fiber, and 20 wt % of a PP fiber, and the sound insulating layer including 20 wt % of a PET fiber, 40 wt % of a LM PET fiber, 20 wt % of a PP fiber, and 20 wt % of a thermoplastic resin prepared in Example 3 was thermally fused to the other surface of the sound absorbing layer. The sound insulating layer on which a thermoplastic film was laminated and the sound insulating layer impregnated with a thermoplastic resin were thermally fused to prepare a soundproof material having a sound absorbing layer/sound insulating layer/sound absorbing layer structure. The soundproof material demonstrated better mechanical strength than that of Comparative Example 3 (FIGS. 11 and 12).

### Example 5

A sound insulating layer including 30 wt % of a PET fiber, 40 wt % of a LM PET fiber, 30 wt % of a PP fiber, and 50 g/m² of a thermoplastic film was laminated on one surface of a sound absorbing layer including 50 wt % of thermosetting polyurethane foam obtained by crushing seats of end-of-life vehicles into fine particles, 10 wt % of a PET fiber, 20 wt % of a LM PET fiber, and 20 wt % of a PP fiber, and the sound insulating layer including 20 wt % of a PET fiber, 40 wt % of a LM PET fiber, 20 wt % of a PP fiber, and 20 wt % of a thermoplastic resin prepared in Example 3 was thermally fused to the other surface of the sound absorbing layer. The sound insulating layer on which a thermoplastic film was laminated and the sound insulating layer impregnated with a thermoplastic resin were thermally fused to prepare a soundproof material having a sound insulating layer/sound absorbing layer/sound insulating layer structure. The soundproof material demonstrated better mechanical strength than that of Comparative Example 3 (FIGS. 11 and 12).

### Example 6

10 wt % of a PET fiber, 10 wt % of a LM PET fiber, 10 wt % of a glass fiber, and 20 wt % of a thermoplastic resin were introduced into 50 wt % of thermosetting polyurethane foam obtained by crushing PU foam from seats of end-of-life vehicles into fine particles. Use of the glass fiber instead of the PP fiber used in Example 1 provided an increase in mechanical strength of a product and a decrease in the shrinkage rate of the product, but processability for the preparation of a felt deteriorated and weight of the product increased. However, mechanical strength of the product was excellent similar to that of Comparative Example 3.

### Comparative Example 1

In order to compare objective utility of soundproof properties according to the impregnation of the thermoplastic resin, the lamination of the thermoplastic film, the lamination of the fiber felt, and the like, evaluations were performed by using a soundproof material according to the prior art which included 50 wt % of thermosetting polyurethane foam obtained by crushing PU foam from seats of end-of-life vehicles into fine particles, 10 wt % of a PET fiber, 20 wt % of a LM PET fiber, and 20 wt % of a PP fiber.

### Comparative Example 2

In order to compare objective utility of recycled waste seat foam (thermosetting polyurethane foam) applied to soundproof materials of automobiles, evaluations were performed by using a commercially available soundproof material including 60 wt % of a PET and 40 wt % of a LM (low-melting) PET (FIGS. 11 and 12, and general soundproof materials).

### Comparative Example 3

In order to compare objective utility of recycled waste seat foam (thermosetting polyurethane foam) applied to soundproof materials of automobiles, evaluations were performed by using a commercially available natural fiber reinforced board.

Table 1 below shows working conditions for preparing soundproof materials according to Examples 1, 2, 3, and 4 according to the present invention. These conditions are only exemplary, and, thus, embodiments of the present invention are not limited thereto.

TABLE 1

| | Class | | | | | | |
|---|---|---|---|---|---|---|---|
| | | | | | | Heat | |
| | Crushing | Mixing | Carding | Stacking | Needle-punching | roller | Cutting |
| Working | Crushing | First | Second | Stacking | Improve physical | Bind | Cut to |
| | waste | mixing | mixing of | the web to | binding force | foam | uniform |
| | seats | of the | foam/fibers | proper | between fibers | with | size |
| | (1 to 10 mm) | crushed | and | thickness | and between | fibers | |
| | | seat | forming a | and | foam and fibers | while | |
| | | foam | web | according | | binder | |
| | | with | | to weight | | melts | |
| | | fibers | | | | by | |
| | | | | | | heat | |
| Conditions | Crusher | Roll | Carding | Stacking | First (300 to 600 rpm) | 80 to | — |
| | (1500 to | mixing | speed | speed | Second (300 to | 220° C. | |
| | 2000 rpm) | (3 times | (1000 to | (5 to 6 m/min) | 900 rpm) | | |
| | Classifier | or | 2000 rpm) | | Depth: 4 to 10 mm | | |
| | (2 to | more) | | | | | |
| | 15Ø) | | | | | | |

### Experimental Example

1) Evaluation of Physical Properties

In order to evaluate physical properties of soundproof felts prepared according to the examples, a sample was prepared by pre-heating a heat press at 200 to 230° C. for 1 minute and cold press molding.

(1) Thickness: measured using a micrometer

(2) Dimensional variation: a sample having a size of 300 mm*300 mm was collected and reference lines were drawn parallel to each edge of the sample inwardly from the edge by 50 mm. An average distance between facing reference lines was accurately measured by using more than 3 samples and set as an original distance. The samples were immersed in water at room temperature for 5 hours and dried in a constant temperature bath at 80±2° C. for 24 hours. The samples were maintained at room temperature for 1 hour and an average distance between the facing reference lines was measured, and then dimensional stability was calculated by using the following formula:

Dimensional Stability(%)=(|Distance between reference lines before test−Distance between reference lines after test|)/(Distance between reference lines before test)

(3) Impact intensity: the samples were maintained in the same condition as they would be subjected to in a vehicle, and a falling impact ball of 1 pound-feet (e.g.: weight: 453 g and height: 30 cm) was dropped thereon. Then, appearance was observed.

(4) Flexural strength: Flexural strengths of 5 samples of 50 mm*150 mm were measured using a flexural strength measuring device (universal testing machine (UTM)).

(5) Soundproof property was evaluated in a reverberation room.

Meanwhile, components of compositions of the recycled PU foam soundproof material according to the present invention are described in more detail below.

\textcircled{1} Waste Seats

Crushed polyurethane PU foam of waste seats used herein were obtained from seats of end-of-life vehicles or automobile shredder residues (cut into pieces of uniform size), and, thus, a crushing process was required for recycling.

Currently, since a technique of recycling polyurethane foam has not been developed, the polyurethane foam is sent to landfills or treated by combustion, thereby causing environmental contamination.

\textcircled{2} Polyurethane Foam

Polyurethane foam used herein is a thermosetting material that, unlike thermoplastic materials, cannot be recycled. Polyol and isocyanate were mixed and foamed to produce polyurethane foam, and the polyurethane foam weighed about 10 kg in a car. The content of the PU foam was in a range of 10 to 80 wt %.

\textcircled{3} Polyethylene Terephthalate (PET) Fiber

The PET fiber used herein had a melting point of 160 to 190° C. and a thickness of 2 to 10 de. (wherein “de” denotes linear mass density of the fibers). Due to excellent mechanical strength and heat resistance, the PET fiber was used to improve the shape and heat resistance of the soundproof material. The content of the PET fiber was in a range of 10 to 80 wt %.

\textcircled{4} Low Melting Point Polyethylene Terephthalate (LM PET) Fiber

The LM PET fiber used herein had a melting point of 100 to 190° C. and a thickness of 3 to 10 de. The LM PET fiber is used as a binder in the soundproof material. The content of the LM PET fiber is in a range of 5 to 50 wt %.

\textcircled{5} Polypropylene (PP)-Based Fiber

The PP fiber used herein has a melting point of 130 to 150° C. and a thickness of 2 to 10 de. The PP fiber was used as a binder in the soundproof material and was used to replace the PET fiber to reduce a molding temperature. The content of the PP fiber was in a range of 2 to 30 wt %.

\textcircled{6} Jute

The Jute was used herein to improve mechanical rigidity. The content of the jute was in a range of 2 to 30 wt %.

\textcircled{7} Glass Fiber

The glass fiber was used herein to improve mechanical properties of the soundproof material. The content of the glass fiber was in a range of 1 to 30 wt %.

\textcircled{8} Thermoplastic Polymer Resin and Film

The thermoplastic polymer resin and film were used herein to improve sound insulating property and mechanical property. 1 to 50 wt % of the thermoplastic resin or 1 to 500 g/m² of the thermoplastic film may be used based on the weight of the soundproof material.

Meanwhile, according to embodiments of the present invention, a nonflammable nonwoven fabric were further added to a composition including components \textcircled{2}, \textcircled{3}, \textcircled{4} and \textcircled{8}, a composition including components \textcircled{2}, \textcircled{3}, \textcircled{4}, \textcircled{5}, \textcircled{6} and \textcircled{8}, a composition including components \textcircled{2}, \textcircled{3}, \textcircled{4}, \textcircled{7} and \textcircled{8}, or a composition including components \textcircled{2}, \textcircled{3}, \textcircled{4}, \textcircled{5}, \textcircled{6}, \textcircled{7} and \textcircled{8} according to use thereof in addition to the components described above.

2) Evaluation of Sound Absorbing Property and Dimensional stability

Table 2 below shows contents of components of the soundproof materials according to embodiments of the present invention, rigidity of the soundproof materials, sound absorbing property, sound insulating property, and appearance of products by impregnation of the thermoplastic resin and lamination of the thermoplastic film.

TABLE 2

| | | | | | | | | | Comp. | Comp. | Comp. |
|---|---|---|---|---|---|---|---|---|---|---|---|
| Class | | Ex. 1 | | Ex. 2 | Ex. 3 | Ex. 4 | Ex. 5 | Ex. 6 | Ex. 1 | Ex. 2 | Ex. 3 |
| Sound | Seat foam | 50 | 50 | 50 | 50 | 50 | 50 | 50 | — | Natural | |
| absorbing | (wt %) | | | | | | | | | fiber | |
| material | PET fiber | 10 | 10 | 10 | 10 | 10 | 10 | 10 | 60 | reinforced | |
| | (wt %) | | | | | | | | | board | |
| | LM PET fiber | 10 | 20 | 20 | 20 | 20 | 10 | 20 | 40 | | |
| | (wt %) | | | | | | | | | | |
| | PP fiber (wt %) | 10 | 20 | 20 | 20 | 20 | — | 20 | — | | |
| | Glass fiber | — | — | — | — | — | 10 | | | | |
| | (wt %) | | | | | | | | | | |
| Sound | Thermoplastic | 20 | — | 20 | 50 | — | 20 | — | — | | |
| insulating | resin (wt %) | | | | | | | | | | |
| material | (polypropylene) | | | | | | | | | | |
| | Thermoplastic | — | 50 | — | — | 50 | — | — | — | | |
| | film (g/m²) | | | | | | | | | | |
| | (polypropylene) | | | | | | | | | | |

| | | | | | | | | | |
|---|---|---|---|---|---|---|---|---|---|
| fiber felt | PET | — | — | 20 | — | 20 | — | — | — |
| (thermoplastic | fiber (wt %) | | | | | | | | |
| resin | LM PET | — | — | 40 | — | 40 | — | — | — |
| impregnation) | fiber (wt %) | | | | | | | | |
| | PP | — | — | 20 | — | 20 | — | — | — |
| | fiber (wt %) | | | | | | | | |
| fiber felt | PET | — | — | — | 30 | 30 | — | — | — |
| (thermoplastic | fiber (wt %) | | | | | | | | |
| film lamination) | LM PET | — | — | — | 40 | 40 | — | — | — |
| | fiber (wt %) | | | | | | | | |
| | PP | — | — | — | 30 | 30 | — | — | — |
| | fiber (wt %) | | | | | | | | |

| Thickness (mm) | 15 | | 15 | 15 | 15 | 15 | 15 | 15 | 15 | 3 |
|---|---|---|---|---|---|---|---|---|---|---|
| Dimensional stability (%) | width | 0.3 | 0.2 | 0.2 | 0.2 | 0.2 | 0.2 | 0.2 | 0.2 | 0.3 |
| | length | 0.3 | 0.2 | 0.2 | 0.2 | 0.2 | 0.2 | 0.2 | 0.2 | 0.3 |

| | | | | | | | | | |
|---|---|---|---|---|---|---|---|---|---|
| Impact intensity | No | No | No | No | No | No | No | No | No |
| | change | change | change | change | change | change | change | change | change |
| Flexural strength (MPa) | 36 | 38 | 41 | 43 | 46 | 40 | 30 | 34 | 40 |

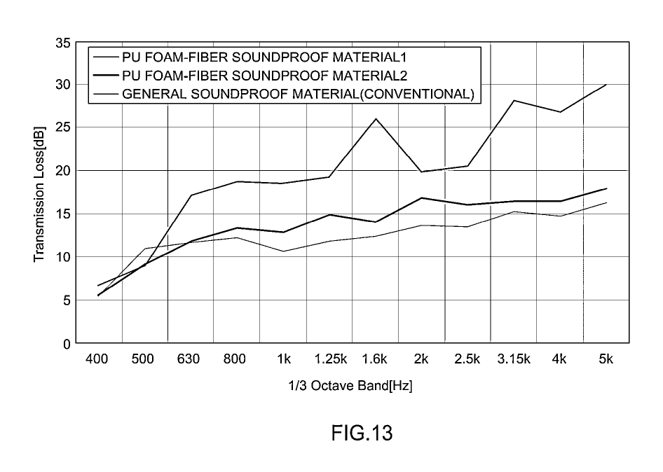

As shown in Table 2 and FIGS. 12 and 13, it was identified, as a result of comparing sound absorbing property, sound insulating property, and mechanical strength of the soundproof materials prepared in Examples 1-5 in accordance with the present invention and Comparative Example 1-3, that sound absorbing property, sound insulating property, and mechanical strength of the soundproof materials prepared using polyurethane foam of waste seats according to Examples 1 and 2 were not inferior to those of the commercially available soundproof material prepared according to Comparative Example 2.

In addition, the soundproof materials prepared using the sound insulating material impregnated with the thermoplastic resin or the sound insulating material laminated with the thermoplastic film and the sound absorbing material according to Examples 3-5 exhibited better mechanical strength than those prepared according to Comparative Examples 1-3.

Thus, by using recycled polyurethane foam to prepare soundproof materials having excellent sound absorbing property, sound insulating property, and mechanical strength, desirable physical properties and excellent appearance of the final products may be obtained, manufacturing costs for automobile parts may be reduced, and the weight of the vehicles may be reduced since the weight of the seat foam is about 1/20 of conventionally used soundproof materials. Furthermore, soil contamination may be prevented and recycling of resources may be increased by using recycled parts of end-of-life vehicles.

According to the present invention, by recycling seats of end-of-life vehicles, manufacturing costs for automobile parts may be reduced and the weight of automobile parts may be reduced since the weight of the seat foam is about 1/20 of conventional soundproof materials. Furthermore, soil contamination may be prevented and recycling of resources may be increased by using recycled parts of end-of-life vehicles so as to efficiently cope with domestic and overseas end-of-life vehicles directives that stipulate the re-use and recycling shall be increased to a minimum of 85% (by the year of 2015).

According to the present invention, not only is sound absorbing property improved, but also improvements in mechanical rigidity and sound insulating property can be achieved by impregnating the soundproof material with a thermoplastic polymer resin or laminating a thermoplastic polymer film on the soundproof material. The soundproof material may be applied to automobile parts that require rigidity such as package trays, luggage coverings, covering shelves, and isolation pads.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A soundproof material comprising:
a sound absorbing material comprising crushed polyurethane (PU) foam, a polyester-based fiber, and a low melting point polyester-based fiber; and
a thermoplastic polymer.

2. The soundproof material of claim 1, wherein the polyurethane foam is waste seat foam or thermosetting polyurethane foam.

3. The soundproof material of claim 1, wherein the polyester-based fiber is selected from the group consisting of polyglycolic acid (PGA), poly lactic acid (PLA), polyethylene adipate (PEA), polyhydroxy alkanoate (PHA), polyethylene terephthalate (PET), polybutylene terephthalate (PBT), polytrimethylene terephthalate (PTT), polyethylene naphthalate (PEN), and combinations thereof.

4. The soundproof material of claim 1, wherein the thermoplastic polymer is selected from the group consisting of acrylonitrile-butadiene-styrene (ABS), celluloid, cellulose acetate, ethylene-vinyl acetate, ethylene vinyl alcohol, polyoxy methylene, polyacrylate, polyamide, polyamide imide, polyaryl etherketon, polybutadiene, polybutylene, polybutylene terephthalate, polycaprolactone, polyethylene terephthalate, polycyclohexylene dimethylene terephthalate, polycarbonate, polyethylene, polyether imide, polyimide, polylactic acid, polymehtyl pentene, polyphenylene oxide, polyphenylene sulfide, polyphtalaimide, polypropylene, polystyrene, polysulfone, polyurethane, polyvinyl acetate, polyvinyl chloride, styrene-acrylonitrile, and combinations thereof.

5. The soundproof material of claim 1, wherein the thermoplastic polymer is in the form of a thermoplastic resin or a thermoplastic film.

6. The soundproof material of claim 5, wherein the sound absorbing material is impregnated with the thermoplastic resin.

7. The soundproof material of claim 5, the thermoplastic film is laminated on the sound absorbing material.

8. The soundproof material of claim 1, wherein the sound absorbing material comprises about 10 to 80 wt % of the crushed polyurethane foam, about 10 to 60 wt % of the polyester-based fiber, and about 10 to 60 wt % of the low melting point polyester-based fiber based on the total weight of the sound absorbing material, and wherein the thermoplastic polymer is about 1 to 50 wt % of a thermoplastic resin or about 1 to 500 g/m² of a thermoplastic film based on the total weight of the sound absorbing material.

9. The soundproof material of claim 1, further comprising (a) about 1 to 50 wt % of a polypropylene (PP) fiber, about 1 to 30 wt % of a glass fiber, and about 1 to 30 wt % of yarn, or (b) about 1 to 30 wt % of a mixture of PP fiber, glass fiber, and/or yarn.

10. The soundproof material of claim 9, wherein the yarn is selected from the group consisting of jute, flax, linen, hemp, ramie, and combinations thereof.

11. The soundproof material of claim 1, wherein the soundproof material comprises about 100 to 3000 g/m² of the sound absorbing material, and the thermoplastic polymer is about 1 to 50 wt % of a thermoplastic resin or about 1 to 500 g/m² or a thermoplastic film based on the weight of the sound absorbing material.

12. A process of fabricating a soundproof material, the process comprising the steps of:
(a) crushing polyurethane foam into fine particles;
(b) preparing a sound absorbing material by mixing the crushed polyurethane foam obtained in step (a) with a polyester-based fiber and a low melting point polyester-based fiber;
(c) carding the sound absorbing material;
(d) needle-punching the sound absorbing material;
(e) thermal-molding and cooling the sound absorbing material; and
(f) impregnating the sound absorbing material prepared in step (e) with a thermoplastic polymer resin or laminating a thermoplastic polymer film on the sound absorbing material, and heat-rolling and cutting the resultant.

13. The process of claim 12, wherein the polyurethane foam is obtained from waste vehicle seats.

14. The process of claim 12, wherein the sound absorbing material prepared in step (e) is prepared in a felt shape.

15. The process of claim 12, wherein the crushed polyurethane foam has a size in a range of about 1 to 15 mm in step (b).

16. The process of claim 12, wherein the sound absorbing material in step (b) further comprises (a) about 1 to 50 wt % of a polypropylene (PP) fiber, about 1 to 30 wt % of a glass fiber, and about 1 to 30 wt % of yarn, or (b) about 1 to 30 wt % of a mixture of PP fiber, glass fiber, and/or yarn based on the total weight of the sound absorbing material.

17. The process of claim 12, wherein the sound absorbing material comprises about 10 to 80 wt % of the crushed polyurethane foam, about 10 to 60 wt % of the polyester-based fiber, and about 10 to 60 wt % of the low melting point polyester-based fiber based on the total weight of the sound absorbing material, wherein the thermoplastic polymer is about 1 to 50 wt % of a thermoplastic resin or about 1 to 500 g/m² of a thermoplastic film based on the total weight of the sound absorbing material.

18. The process of claim 12, wherein the soundproof material comprises about 100 to 3000 g/m² of the sound absorbing material, and the thermoplastic polymer is about 1 to 50 wt % of a thermoplastic resin or about 1 to 500 g/m² of a thermoplastic film based on the weight of the sound absorbing material.

19. A soundproof material having a stack structure that comprises:
a sound absorbing layer that is a foam fiber felt comprising a crushed polyurethane foam, a polyester-based fiber, and a low melting point polyester-based fiber;
a sound insulating layer that comprises a fiber board formed of a polyester-based fiber, a low melting point polyester-based fiber, and a polypropylene fiber; and
a thermoplastic polymer.

20. The soundproof material of claim 19, wherein the thermoplastic polymer is in the form of a thermoplastic resin or a thermoplastic film.

21. The soundproof material of claim 19, wherein the sound absorbing material is impregnated with the thermoplastic resin.

22. The soundproof material of claim 19, wherein the thermoplastic film is laminated on the sound absorbing material.

23. The soundproof material of claim 19, wherein the sound absorbing layer comprises about 10 to 80 wt % of the crushed polyurethane foam, about 10 to 60 wt % of the polyester-based fiber, and about 10 to 60 wt % of the low melting point polyester-based fiber based on the total weight of the sound absorbing layer, and the sound insulating layer comprises about 10 to 60 wt % of the polyester-based fiber, about 10 to 60 wt % of the low melting point polyester-based fiber, about 10 to 50 wt of the polypropylene fiber, and about 1 to 50 wt % of a thermoplastic resin or about 1 to 500 g/m² of a thermoplastic film as a thermoplastic polymer based on the total weight of the sound insulating layer.

24. The soundproof material of claim 19, wherein the sound absorbing layer and/or the sound insulating layer further comprise (a) about 10 to 50 wt % of a polypropylene (PP) fiber, about 1 to 30 wt % of a glass fiber, and about 1 to 30 wt % of yarn, or (b) about 1 to 30 wt % of a mixture of PP fiber, glass fiber and/or yarn.

25. The soundproof material of claim 19, wherein the soundproof material comprises about 100 to 3000 g/m² of the sound absorbing layer and about 50 to 1000 g/m² of the sound insulating layer.

26. A process of fabricating a soundproof material, the process comprising the steps of:
(a) crushing polyurethane foam from vehicle waste seats into fine particles;
(b) preparing a sound absorbing material by mixing the crushed polyurethane foam obtained in step (a) with a polyester-based fiber and a low melting point polyester-based fiber;
(c) carding the sound absorbing material;
(d) needle-punching the sound absorbing material;
(e) thermal-molding and cooling the sound absorbing material;
(f) preparing a sound insulating material by mixing a polyester-based fiber, a low melting point polyester-based fiber, and a polypropylene fiber;
(g) carding the sound insulating material;
(h) needle-punching the sound insulating material;
(i) thermal-molding and cooling the sound insulating material so as to provide a felt shape;
(j) impregnating the sound insulating material prepared in step (i) with a thermoplastic polymer resin or laminating a thermoplastic polymer film on the sound insulating material, followed by heat-rolling and cutting; and
(k) stacking the sound absorbing layer and the sound insulating layer which are respectively formed in steps (e) and (j), and heat-rolling and cutting the stack.

27. The process of claim 26, wherein the sound absorbing layer and/or the sound insulating layer further comprise (a) about 10 to 50 wt % of a polypropylene fiber, about 1 to 30 wt % of a glass fiber, about 1 to 30 wt % of yarn, or (b) about 1 to 30 wt % of a mixture of PP fiber, glass fiber and/or yarn.

28. The process of claim 26, wherein the sound absorbing layer comprises about 10 to 80 wt % of the crushed polyurethane foam, about 10 to 60 wt % of the polyester-based fiber, and about 10 to 60 wt % of the low melting point polyester-based fiber based on the total weight of the sound absorbing layer, and the sound insulating layer comprises about 10 to 60 wt % of the polyester-based fiber, about 10 to 60 wt % of the low melting point polyester-based fiber, about 10 to 50 wt % of the polypropylene fiber, and about 1 to 50 wt % of a thermoplastic resin or about 1 to 500 g/m² of a thermoplastic film as a thermoplastic polymer based on the total weight of the sound insulating layer.

29. The process of claim 26, wherein the soundproof material comprises about 100 to 3000 g/m² of the sound absorbing layer and about 50 to 1000 g/m² of the sound insulating layer.

30. The process of claim 26, wherein the soundproof material has a multi-layered structure of a sound absorbing layer/sound insulating layer/sound absorbing layer structure by further stacking the sound absorbing layer on the sound insulating layer.

31. The process of claim 26, wherein the soundproof material has a multi-layered structure of a sound insulating layer/sound absorbing layer/sound insulating layer structure by further stacking the sound insulating layer on the sound absorbing layer.
